(19) United States
(12) Patent Application Publication
(10) Pub. No.: US 2005/0052835 A1
(43) Pub. Date: Mar. 10, 2005

(54) Dual-screen display apparatus and information processing apparatus having the same

(76) Inventors: Chi-Jung Wu, Taoyuan City (TW); Ting-Hui Chih, Hualien City (TW)

Correspondence Address: SNELL & WILMER;ONE ARIZONA CENTER, 400 EAST VAN BUREN, PHOENIX, AZ, 850040001, US

(21) Appl. No.: 10/936,980

(22) Filed: Sep. 9, 2004

(30) Foreign Application Priority Data
Sep. 10, 2003 (TW) 92125075

(51) Int. Cl. G06F 1/16

(52) U.S. Cl. 361/681

(57) ABSTRACT

A dual-screen display apparatus and a dual screen information processing apparatus are provided. The apparatus includes a first casing, a second casing, and a touch panel input device. The first casing having a first display panel and the second casing having a second display panel are pivotally connected to each other. When the first and the second casings are in a folded configuration, the first display panel faces the second display panel with the touch panel input device being accommodated therebetween. When the first and the second casings are in an unfolded configuration, the first display panel and the second display panel are respectively positioned to face different directions, and the touch panel input device is configured to input information.

### CROSS-REFERENCE TO RELATED APPLICATIONS

This application claims priority to Taiwan Patent Application No. 092125075 entitled “Dual-Screen Display Apparatus and Information Processing Apparatus”, filed on Sep. 10, 2003.

### FIELD OF INVENTION

The present invention generally relates to a dual-screen electronic apparatus and, more particularly, to a dual-screen display apparatus or a dual-screen information processing apparatus showing information in multiple directions.

### BACKGROUND OF THE INVENTION

As the information technology advances, the business interactions favorably rely on the support of electronic products. For example, the portability of laptop computers facilitates the presentation of pre-stored information in all kinds of occasions. When a lap top computer works with a projection system, information stored in the laptop computer can be presented in front of a group of people. However, when the information presented for a one-on-one occasion or for a small group of people, the use of projection system is impractical and costly. Therefore, using the built-in screen of the laptop computer to display stored information is a feasible option.

However, in the case of a one-on-one presentation, the user and the viewer often sit face to face. Therefore, the user has difficulty showing the viewer what is displayed on the screen during operation of the computer. If the user wants to show the screen of the laptop computer to another person, the user must suspend the operation of the computer and turn around the whole computer. Such actions are often repeated during the presentation that degrades the performance of the presentation. Otherwise, the viewer must stand behind the user to look at the screen to share the same information. Therefore, as the number of viewers increases, people are crowded around the user inducing inconveniences of operation.

It is therefore desirable to provide a dual-screen display apparatus or a dual-screen information processing apparatus, which is capable of displaying information in multi-direction so as to promote the viewing comfortability to a small group of viewers.

### SUMMARY OF THE INVENTION

One aspect of the present invention is to provide a dual-screen display apparatus or an information processing apparatus, which has two display panels capable of facing different display directions so that users and viewers can view same information face to face.

Another aspect of the present invention is to provide a dual-screen display apparatus or an information processing apparatus, which includes a touch panel input device so that the space for positioning an external keyboard in an operating environment is not necessary.

In one embodiment, the present invention provides a dual-screen electronic apparatus, such as a dual-screen display apparatus or a dual-screen information processing apparatus, which includes a first casing, a second casing, and a touch panel input device. The first casing, which is pivotally connected to the second casing, has a first display panel, and the second casing has a second display panel. The touch panel input device is coupled to the first casing. When the first casing and the second casing are folded together to form a folded configuration, the first display panel faces the second display panel with the touch panel input device being accommodated therebetween. Furthermore, when the first casing and the second casing are in an unfolded configuration, the first display panel and the second display panel are respectively positioned to face different directions, and the touch panel is configured to input information.

In accordance with one embodiment of the present invention, the second casing is rotatably coupled to said first casing. When the first and second casings are in the unfolded configuration, the second casing rotates at an angle with respect to the first casing to change a display direction of the second display panel. Alternatively, the second casing is detachably connected to the first casing. When the first and the second casings are in the unfolded configuration, the second casing is detached from the first casing so as to change the display direction of the second display panel.

Furthermore, the touch panel input device includes an input portion and a transparent portion. The input portion is provided for inputting the information, while the transparent portion is configured to expose the information display on the first display panel. The dual-screen display apparatus further includes a controller for controlling the information to be displayed on the first display panel and/or the second display panel.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B illustrate three-dimensional views of a dual-screen display apparatus in an unfolded configuration in accordance with one embodiment of the present invention;

FIGS. 2A and 2B illustrate three-dimensional views of a dual-screen display apparatus in an unfolded configuration in accordance with another embodiment of the present invention; and

FIGS. 3A and 3B illustrate three-dimensional views of a dual-screen display apparatus in an unfolded configuration in accordance with a further another embodiment of the present invention.

### DETAILED DESCRIPTION

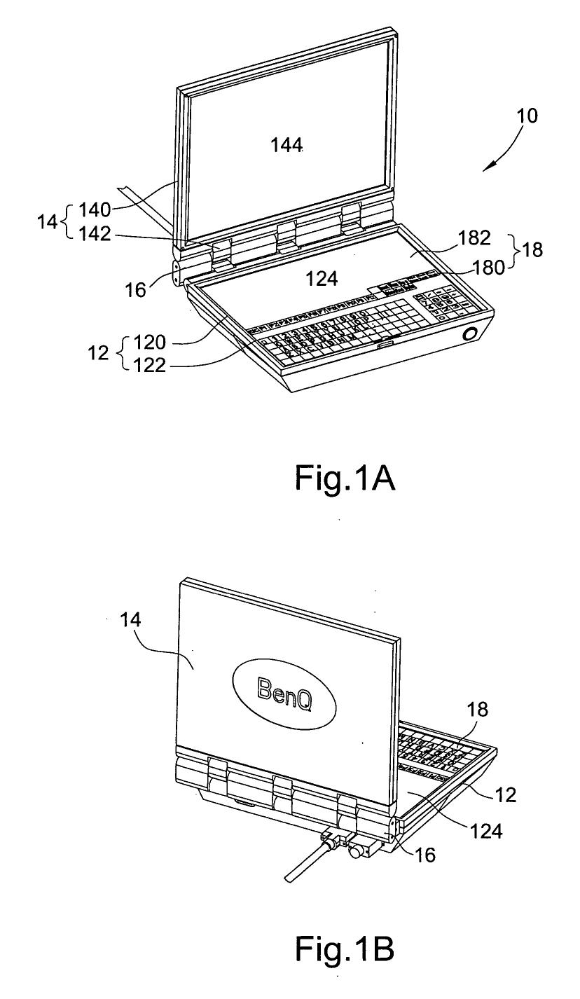

The present invention provides a dual-screen electronic apparatus, such as a dual-screen display apparatus or a dual-screen information processing apparatus, which has two display panels capable of facing different display directions so that users and viewers can view same information face to face. FIGS. 1A and 1B illustrate three-dimensional views of a dual-screen display apparatus respectively viewing from the user side and the viewer side in accordance with one embodiment of the present invention. Referring to FIGS. 1A and 1B, the present invention provides a dual-screen display apparatus 10 including a first casing 12, a second casing 14, a connection device 16, and a touch panel input device 18. The first casing 12 includes a first body 120 and a first connection part 122. A first display panel 124 is disposed on the first body 120, and the touch panel input device 18 is coupled to the first connection part 122. The second casing 14 includes a second body 140 and a second connection part 142. A second display panel 144 is disposed on the second body 140, while the connection part 142 is pivotally connected to the first casing 12 through the connection device 16.

The first casing 12 and the second casing 14 can be selectively in a folded configuration and an unfolded configuration. That is, when the dual-screen display apparatus 10 is not in use, the first casing 12 and the second casing 14 are folded together to form the folded configuration so as to protect the first display panel 124 and the second display panel 144 by means of the first body 120 and the second body 140. While in the folded configuration, the first display panel 124 faces the second display panel 144 with the touch panel input device 18 being accommodated therebetween. When the dual-screen display apparatus 10 is to be used, the first casing 12 and the second casing 14 are in the unfolded configuration. When in the unfolded configuration, the first display panel 124 and the second display panel 144 are respectively positioned to face different display directions, and the touch panel input device 18 is provided for inputting information that is to be displayed on the first display panel 124 and/or the second display panel 144.

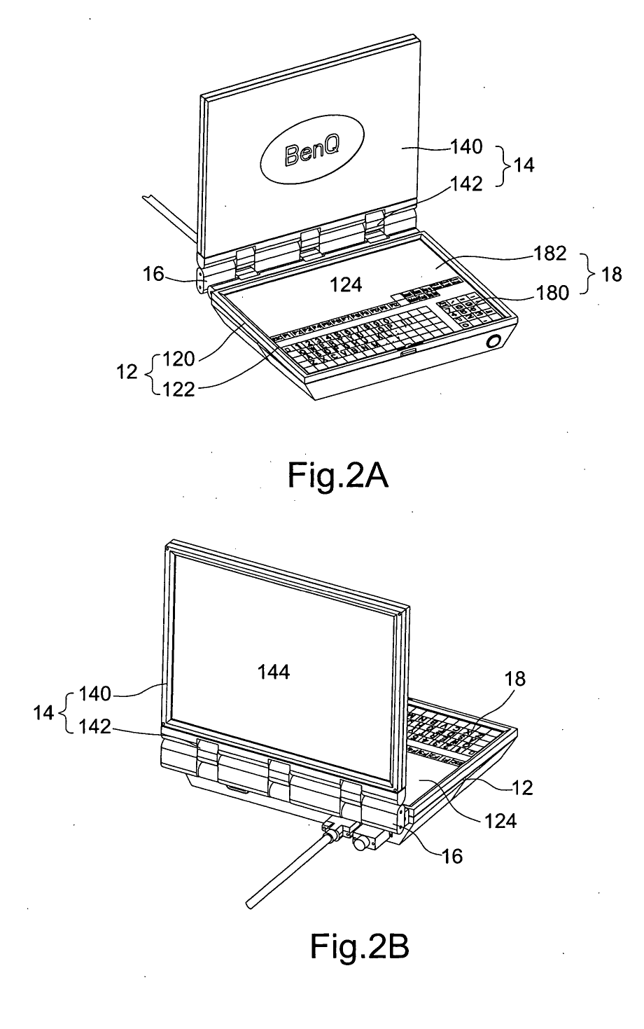

For example, as shown in FIGS. 1A and 1B, the first casing 12 and the second casing 14 are in the unfolded configuration, and the first display panel 124 and the second display panel 144 are both positioned to face the user. When a single user sits in front of the dual-screen display apparatus 10, the user can view information displayed on the two display panels at the same time. When the user intends to share the information with other viewers, the second display panel 144 is selectively adjusted so as to change its position to face a different display direction. Therefore, the user and the viewer can sit face to face instead of side by side to view the same information on the first display panel 124 and the second display panel 144, respectively. FIGS. 2A and 2B illustrate three-dimensional views of the dual-screen display apparatus 10 respectively viewing from the user side and the viewer side. As shown in FIG. 2B, the first casing 12 is rotatably coupled to the second casing 14. When the first casing 12 and the second casing 14 are in the unfolded configuration, the second body 140 vertically rotates at an angle, such as 180 degree, with respect to the first casing 12 so as to change the display direction of the second display panel 144. In comparison with the embodiment of FIG. 1B, the display panel 144 shown in FIG. 2B rotates about 180 degrees and substantially faces the opposite direction. In such arrangement, the user and the viewer can sit on two opposite sides with respect to the dual-screen display apparatus 10 and view information inputted by the touch panel input device 18 from the first display panel 124 and the second display panel 144 respectively. Alternatively, in another embodiment (not shown), the second casing 14 is detachably connected to the first casing 12. When the first casing 12 and the second casing 14 are in the unfolded configuration, the second casing 14 is detached from the first casing 12 so as to change the display direction of the second display panel 144. In other words, the second casing 14 is detachably coupled to the first casing 12 in multiple directions, so that the display direction of the second display panel 144 can be adjusted to fulfill the user's need or to achieve the configuration shown in FIGS. 2A and 2B.

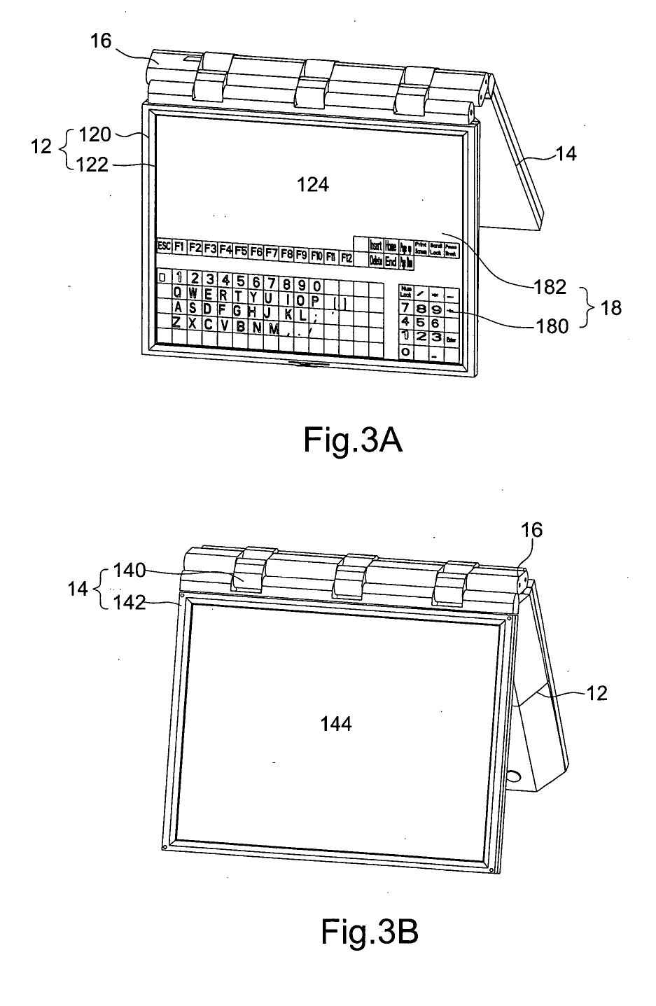

FIGS. 3A and 3B illustrate three-dimensional views of the dual-screen display apparatus 10 respectively viewing from the user side and the viewer side in accordance with another embodiment of the present invention. Referring to FIGS. 3A and 3B, the first casing 12 and the second casing 14 are rotatably connected. When the first casing 12 and the second casing 14 are in the unfolded configuration, the second casing 14 rotates at an angle (such as larger than 180 degree) with respect to the first casing 12 so as to change the display direction of the second display panel 144. In other words, due to the rotatable connection of the first casing 12 and the second casing 12, the first display panel 124 and the second display panel 144 face opposite directions. Therefore, the user and the viewer can sit on two opposite sides with respect to the dual-screen display apparatus 10 and view same information on the first display panel 124 and the second display panel 144 respectively.

Furthermore, the touch panel input device 18 includes an input portion 180 and a transparent portion 182. The input portion 180 is provided for inputting information, while the transparent portion 182 is configured to expose information displayed on the first display panel 124. The input portion 180 can be a conventional QWERTY film type keyboard, while the transparent portion 182 can be an opening or a transparent film. The touch panel input device 18 can be designed to be detachably coupled to the first casing 12. In such arrangement, when the dual-screen display apparatus 10 is used with an information processing apparatus, such as a personal computer (not shown) for a long time without the need for inputting information, for example, displaying motion pictures, the touch panel input device 18 can be detached from the first casing 12. Moreover, the dual-screen display apparatus 10 can further include a controller (not shown) for controlling the information to be displayed on the first display panel 124 and/or the second display panel 144. That is, when the user only needs one screen, the controller controls the information to be selectively displayed on the first display panel 124 or the second display panel 144, and the other one is turned off to save power.

It is noted that when the dual-screen electronic apparatus is embodied as a dual-screen monitor, the dual-screen display apparatus can be used with a processor or a computer displaying information to users or viewers on different directions. Furthermore, because of the provision of the touch panel input device 18, the space for positioning a conventional keyboard in an operating environment is not a requisite. Moreover, when the dual-screen electronic apparatus is embodied as a dual-screen information processing apparatus, such as a dual-screen laptop computer, the user and the viewer can sit at the most comfortable position to view same information from different display panels. The application of the dual-screen display apparatus is advantageous to user displaying information to a small group of viewers.

Although specific embodiments have been illustrated and described, it will be obvious to those skilled in the art that various modifications may be made without departing from what is intended to be limited solely by the appended claims.

1. A dual-screen display apparatus, comprising:
a first casing having a first display panel;
a second casing having a second display panel, said second casing pivotally connected to said first casing; and
a touch panel input device coupled to said first casing;
wherein said first display panel faces said second display panel with said touch panel input device being accommodated therebetween when said first and second casings are folded together to form a folded configuration; and said first display panel and said second display panel are respectively positioned to face different directions, and said touch panel input device is configured to input information when said first and second casings are in an unfolded configuration.

2. The dual-screen display apparatus of claim 1, wherein said first casing comprises a first body and a first connection part, said first display panel is disposed on said first body, and said touch panel input device is coupled to said first connection part.

3. The dual-screen display apparatus of claim 2, wherein said second casing comprises a second body and a second connection part, said second panel is disposed on said second body, and said second connection part is pivotally connected to said first casing.

4. The dual-screen display apparatus of claim 3, wherein said second casing is rotatably coupled to said first casing, and said second body rotates at an angle with respect to said first casing so as to change a display direction of said second panel when said first and second casings are in said unfolded configuration.

5. The dual-screen display apparatus of claim 4, wherein said second body vertically rotates at said angle with respect to said first casing so as to change said display direction of said second panel when said first and second casings are in said unfolded configuration.

6. The dual-screen display apparatus of claim 5, wherein said first display panel comprises a first display surface and said second display panel comprises a second display surface, said first display surface faces said second display surface when said first and second casings are in said folded configuration, and said second body selectively vertically rotates about 180° so that said second display surface rotates about 180° with respect to said first display surface when said first and second casings are in said unfolded configuration.

7. The dual-screen display apparatus of claim 3, wherein said second casing is detachably connected to said first casing, and said second casing is detached from said first casing so as to change a display direction of said second display panel when said first and second casings are in said unfolded configuration.

8. The dual-screen display apparatus of claim 1, wherein said touch panel input device comprises an input portion for inputting said information and a transparent portion for exposing said information display on said first display panel.

9. The dual-screen display apparatus of claim 1, further comprising a controller for controlling said information to be displayed on said first display panel and/or said second display panel.

10. An information processing apparatus with a dual-screen display apparatus, comprising:
a first casing having a first display panel;
a second casing having a second display panel, said second casing pivotally connected to said first casing; and
a touch panel input device pivotally coupled to said first casing;
wherein said first display panel faces said second display panel with said touch panel input device being accommodated therebetween when said first and second casings are folded together to form a folded configuration, and said first display panel and said second display panel are respectively positioned to face different directions, and said touch panel input device is configured to input information when said first and second casings are in an unfolded configuration.

11. The information processing apparatus of claim 10, wherein said first casing comprises a first body and a first connection part, said first display panel is disposed on said first body, and said touch panel input device is coupled to said first connection part.

12. The information processing apparatus of claim 11, wherein said second casing comprises a second body and a second connection part, said second panel is disposed on said second body, and said second part is pivotally connected to said first casing.

13. The information processing apparatus of claim 12, wherein said second casing is rotatably coupled to said first casing, and said second body rotates at an angle with respect to said first casing so as to change a display direction of said second panel when said first and second casings are in said unfolded configuration.

14. The information processing apparatus of claim 13, wherein said second body vertically rotates at said angle with respect to said first casing so as to change said display direction of said second panel when said first and second casings are in said unfolded configuration.

15. The information processing apparatus of claim 14, wherein said first display panel comprises a first display surface and said second display panel comprises a second display surface, said first display surface faces said second display surface when said first and second casings are in said folded configuration, and said second body vertically rotates about 180° so that said second display surface rotates about 180° with respect to said first display surface when said first and second casings are in said unfolded configuration.

16. The information processing apparatus of claim 12, wherein said second casing is detachably connected to said first casing, and said second casing is detached from said first casing so as to change a display direction of said second display panel when said first and second casings are in said unfolded configuration.

17. The information processing apparatus of claim 10, wherein said touch panel input device comprises an input portion for inputting said information and a transparent portion for exposing said information display on said first display panel.

18. The information processing apparatus of claim 10, further comprising a controller for controlling said information to be displayed on said first display panel and/or said second display panel.
